(19) United States
(12) Patent Application Publication
(10) Pub. No.: US 2013/0064984 A1
(43) Pub. Date: Mar. 14, 2013

(54) RUBBER ROLL PRODUCING MACHINE AND METHOD OF PRODUCING RUBBER ROLL

(71) Applicant: Eiichi IIDA, Kanagawa (JP)

(72) Inventor: Eiichi IIDA, Kanagawa (JP)

(73) Assignee: FUJI XEROX CO., LTD., TOKYO (JP)

(21) Appl. No.: 13/346,011

(22) Filed: Jan. 9, 2012

(30) Foreign Application Priority Data
Sep. 13, 2011 (JP) 2011-199203

(51) Int. Cl. B05D 1/18; B05C 3/02

(52) U.S. Cl. 427/430.1; 118/404

(57) ABSTRACT

A rubber roll producing machine includes an outer member that is formed in a cylindrical shape, an inner member that is disposed inside the outer member so as to form an annular passageway between the inner member and the outer member, has an outer peripheral surface with a friction coefficient against a rubber material larger than that of an inner peripheral surface of the outer member in a portion of forming the annular passageway, and has an insertion hole formed at a center portion thereof so as to insert a shaft member therethrough, and a discharge portion which allows the rubber material flowing out from the annular passageway to contact the shaft member coming out from the insertion hole and discharges the rubber material and the shaft member to the outside in an integrated state.

### CROSS-REFERENCE TO RELATED APPLICATIONS

This application is based on and claims priority under 35 USC 119 from Japanese Patent Application No. 2011-199203 filed on Sep. 13, 2011.

### BACKGROUND

### Technical Field

The present invention relates to a rubber roll producing machine and a method of producing a rubber roll.

### SUMMARY

According to an aspect of the invention, there is provided a rubber roll producing machine including: an outer member that is formed in a cylindrical shape; an inner member that is disposed inside the outer member so as to form an annular passageway between the inner member and the outer member, has an outer peripheral surface with a friction coefficient against a rubber material larger than that of an inner peripheral surface of the outer member in a portion of forming the annular passageway, and has an insertion hole formed at a center portion thereof so as to insert a shaft member therethrough; and a discharge portion which allows the rubber material flowing out from the annular passageway to contact the shaft member coming out from the insertion hole and discharges the rubber material and the shaft member to the outside in an integrated state.

### BRIEF DESCRIPTION OF THE DRAWINGS

Exemplary embodiments of the present invention will be described in detail based on the following figures, wherein:

FIG. 1 is a diagram illustrating a longitudinal cross-section of a rubber roll producing machine according to an aspect of the invention;

FIG. 2 is a diagram illustrating a transverse cross-section of the rubber roll producing machine taken along the line L2-L2 of FIG. 1;

FIG. 3 is a diagram illustrating a rubber roll producing machine which is a comparative example with respect to the rubber roll producing machine of the exemplary embodiment of the invention, which illustrates a speed distribution of a rubber material flowing through an annular passageway, a speed distribution of the rubber material flowing through a discharge portion, and an uneven thickness of a rubber roll discharged from the discharge opening; and

FIG. 4 is a table illustrating a test result for an uneven thickness of a rubber roll in the axial direction when various combinations of surface treatments are performed on an inner peripheral surface of an outer die and an outer peripheral surface of an inner die.

### DETAILED DESCRIPTION

Hereinafter, an example of an exemplary embodiment of a rubber roll producing machine and a method of producing a rubber roll according to an aspect of the invention will be described with reference to the accompanying drawings.

A rubber roll (a rubber coated shaft body) which is produced in accordance with the rubber roll producing machine and the method of producing the rubber roll according to the exemplary embodiment of the invention is used as, for example, a charging roll which rotates while coming into contact with a photoconductor drum of an image forming apparatus and charges the outer peripheral surface of the photoconductor drum. In order to evenly charge the entire outer peripheral surface while the charging roll comes into close contact with the outer peripheral surface of the photoconductor drum, the uneven thickness of the rubber roll needs to be small. Though the uneven thickness may be suppressed by performing a secondary process such as polishing or surface treatment on the surface of the charging roll, the manufacturing cost inevitably becomes higher as the number of processes becomes larger. For this reason, there has been a demand for a rubber roll producing machine capable of molding a rubber roll with a small uneven thickness without carrying out a secondary process such as polishing or surface treatment.

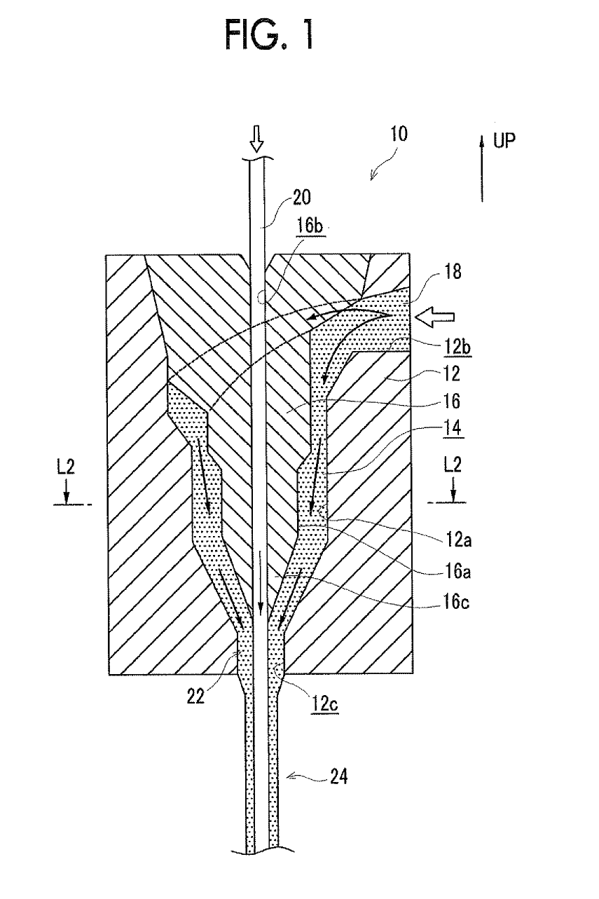

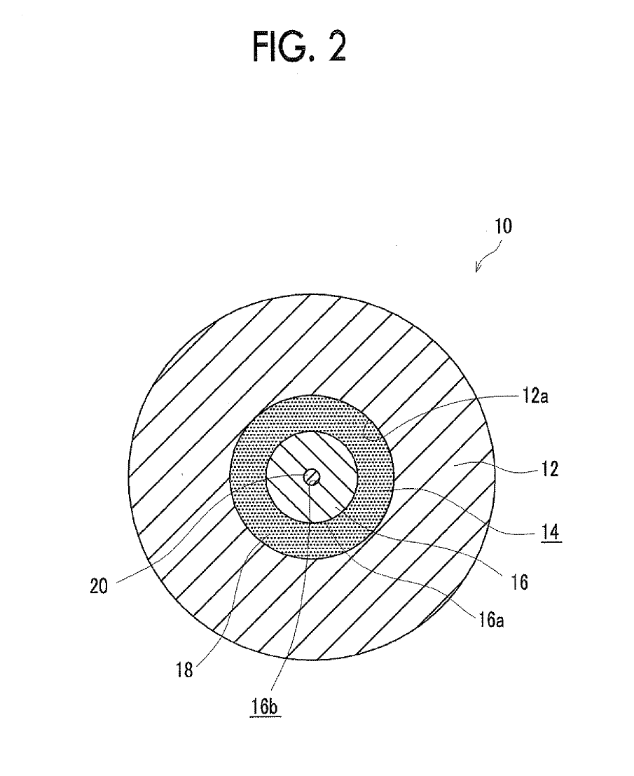

FIG. 1 illustrates the longitudinal cross-section of the rubber roll producing machine according to the exemplary embodiment of the invention. FIG. 2 illustrates the transverse cross-section of the rubber roll producing machine taken along the line L2-L2 of FIG. 1.

A rubber roll producing machine 10 according to the exemplary embodiment of the invention is formed as an extruder which includes a so-called crosshead die. The rubber roll producing machine 10 includes an outer die 12 which is an example of an outer member formed in a substantially cylindrical shape and an inner die 16 which is an example of an inner member disposed inside the outer die 12 so as to form an annular passageway 14 having an annular transverse cross-section between the outer die 12 and the inner die.

The upper portions of the inner die 16 and the outer die 12 are formed in a fitting shape, and the inner die 16 is fitted and fixed to the upper portion of the outer die 12. At the lower portion of the inner die 16 in relation to the fitting-fixing portion with respect to the outer die 12, the annular passageway 14 is formed by the inner die 16 and the outer die 12. That is, a part of an outer peripheral surface 16a of the inner die 16 forms the inner wall of the annular passageway 14, and a part of an inner peripheral surface 12a of the outer die 12 forms the outer wall of the annular passageway 14. An unvulcanized rubber material 18 with fluidity flows through the annular passageway 14.

The inner die 16 and the outer die 12 are formed of the same material, for example, a material such as steel. However, in a portion forming at least the annular passageway 14, as described below, different surface treatment is performed for each of the outer peripheral surface 16a of the inner die 16 and the inner peripheral surface 12a of the outer die 12. Accordingly, the friction coefficient of the outer peripheral surface 16a of the inner die 16 against the rubber material 18 is set to be larger than the friction coefficient of the inner peripheral surface 12a of the outer die 12 against the rubber material 18.

The upper portion of the peripheral wall of the outer die 12 is provided with an introducing hole 12b which introduces the rubber material 18 therethrough. The rubber material 18 is introduced from the introducing hole 12b by an extruding machine (not shown). The rubber material 18 which is introduced from the introducing hole 12b flows downward through the annular passageway 14.

The center portion of the inner die 16 is provided with an insertion hole 16b which is formed in the axial direction by perforating so that a conductive shaft body 20 serving as an example of a shaft member is inserted therethrough. The conductive shaft body 20 is fed from the upside of the insertion hole 16b by a conveying machine (not shown), and is discharged from the downside thereof.

The inner diameter of the outer die 12 becomes smaller as it moves closer to the lower portion of the outer die, and the center portion of the lower surface of the outer die 12 is provided with a circular discharge opening 12c which communicates with the outside. Also, the inner diameter of the inner die 16 becomes smaller as it moves closer to the lower portion of the inner die. In particular, a lower end portion 16c thereof is formed in a conical shape in which the top portion of the conical shape is used as the exit of the insertion hole 16b and the rubber material 18 flowing through the annular passageway 14 is guided to the conductive shaft body 20 discharged from the insertion hole 16b.

The lower portion in relation to the lower end portion 16c of the inner die 16 is formed as a discharge portion 22. At the discharge portion 22, the rubber material 18 which is discharged from the annular passageway 14 contacts (merges with) the conductive shaft body 20 which is discharged from the insertion hole 16b. That is, the rubber material 18 and the conductive shaft body 20 are integrated with each other in a manner such that the rubber material 18 coats the conductive shaft body 20. Then, the rubber material 18 and the conductive shaft body 20 which are integrated with each other are discharged to the outside from a discharge opening 12c provided in the lower surface of the outer die 12. Accordingly, the rubber roll (the rubber coated shaft body) 24 is molded. Furthermore, a primary layer is coated on the outer peripheral surface of the conductive shaft body 20 in advance, and the conductive shaft body 20 and the rubber material 18 adhere to each other through the contact at the discharge portion 22.

In order to produce a rubber roll 24 using the rubber roll producing machine 10, the rubber material 18 is introduced from the introducing hole 12b at a constant flow rate by an extruding machine (not shown). Accordingly, the rubber material 18 flows to the discharge portion 22 through the annular passageway 14 at a constant flow rate. At the same time, the conductive shaft body 20 is introduced into the insertion hole 16b, and is sent downward from the discharge portion 22 so that the conductive shaft body is discharged from the insertion hole 16b at a constant speed. Then, the rubber material 18 and the conductive shaft body 20 are integrated with each other at the discharge portion 22, and the rubber roll 24 with a substantially even thickness (outer diameter) is discharged from the discharge opening 12c. Furthermore, in the exemplary embodiment, the flow rate of the rubber material 18 or the feeding speed of the conductive shaft body 20 is made to be constant, so that the rubber roll 24 with a substantially even thickness is discharged. However, when the feeding speed is changed to a predetermined speed, the thickness of the rubber roll may be changed, and a rubber roll having a so-called crown shape or hand-drum shape may be discharged.

Furthermore, the discharged rubber roll 24 is vulcanized by using an appropriate treatment furnace, is cut into a desired length, and is processed so that the conductive shaft body 20 is exposed by a predetermined length from both end sides of the rubber roll. Accordingly, for example, the rubber roll may be used as a charging roll of an image forming apparatus.

Next, the knowledge which is obtained by the inventors and helps the uneven thickness of the rubber roll 24 to be suppressed will be described.

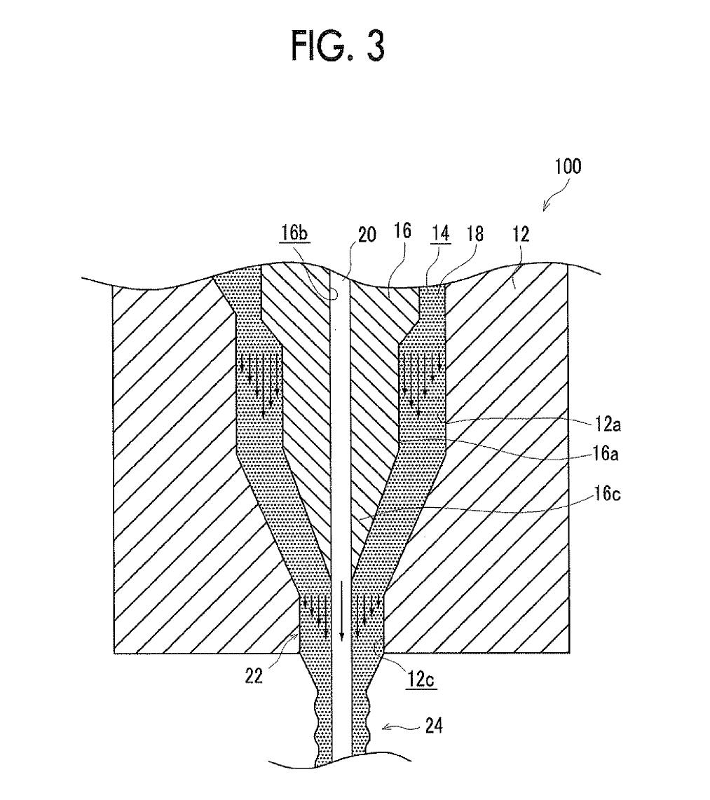

FIG. 3 is a diagram illustrating a rubber roll producing machine 100 which is a comparative example with respect to the rubber roll producing machine 10 of the exemplary embodiment, which illustrates the speed distribution of the rubber material 18 flowing through the annular passageway 14, the speed distribution of the rubber material 18 flowing through the discharge portion 22, and the uneven thickness of the rubber roll 24 discharged from the discharge opening 12c.

The rubber roll producing machine 100 which is a comparative example has the same structure as that of the rubber roll producing machine 10. However, for example, surface treatment such as hard chromium plating is performed on the outer peripheral surface 16a of the inner die 16 and the inner peripheral surface 12a of the outer die 12 of the rubber roll producing machine 100. Thus, the friction coefficient of the outer peripheral surface 16a of the inner die 16 against the rubber material 18 is set to be equal to the friction coefficient of the inner peripheral surface 12a of the outer die 12 against the rubber material 18.

First, the speed distribution of the rubber material 18 which flows through the annular passageway 14 will be described. As schematically illustrated in FIG. 3, the speed of the rubber material 18 which flows to the center portion away from the outer wall (the inner peripheral surface 12a of the outer die 12) of the annular passageway 14 and the inner wall (the outer peripheral surface 16a of the inner die 16) of the annular passageway 14 is large, the speed of the rubber material 18 becomes smaller as it is closer to the outer wall side of the annular passageway 14, and the speed of the rubber material 18 becomes smaller as it is closer to the inner wall side of the annular passageway 14. This is because the flow resistance of the rubber material 18 becomes larger as it is closer to the outer wall side and the inner wall side of the annular passageway 14 due to the friction resistance of the outer wall and the inner wall of the annular passageway 14.

Further, the speed of the rubber material 18 which flows along the outer wall side of the annular passageway 14 is smaller than the speed of the rubber material 18 which flows along the inner wall side of the annular passageway 14. This is because the surface area of the outer wall of the annular passageway 14 is larger than the surface area of the inner wall and the rubber material 18 flowing along the outer wall side of the annular passageway 14 undergoes a flow resistance generated by surface friction larger than the flow resistance exerted on the rubber material 18 flowing along the inner wall side of the annular passageway 14.

Thus, in the rubber roll producing machine 100 as a comparative example, a speed distribution is obtained in which the rubber material 18 flowing through the annular passageway 14 is slow at the outer wall side, but is rapid at the inner wall side as a whole. Then, a difference in speed of the rubber material 18 between the outer wall side and the inner wall side of the annular passageway 14 causes distortion in the rubber material 18. This is because the rubber material 18 flowing slowly along the outer wall side of the annular passageway 14 causes tensile stress and the rubber material 18 flowing rapidly along the inner wall side of the annular passageway 14 causes compressive stress.

Subsequently, the speed distribution of the rubber material 18 which flows through the discharge portion 22 will be described. In the discharge portion 22, the speed of the rubber material 18 is rapid at the contact side with respect to the conductive shaft body 20, and becomes slower as it is closer to the outer wall side. This is because the rubber material 18 flowing out along the inner wall side of the annular passageway 14 contacts the conductive shaft body 20 moving in the same direction and the flow resistance is small at the contact side with respect to the conductive shaft body 20. Accordingly, in the discharge portion 22, a difference in speed between the rubber material 18 flowing along the outer wall side of the annular passageway 14 and the rubber material 18 flowing along the inner wall side of the annular passageway 14 increases. That is, the stronger tensile stress occurs in the rubber material 18 which flows along the outer wall side of the annular passageway 14, and the stronger compressive stress occurs in the rubber material 18 which flows along the inner wall side of the annular passageway 14, so that the distortion occurring in the rubber material 18 increases.

Subsequently, the uneven thickness of the rubber roll 24 which is discharged from the discharge opening 12c will be described. When the conductive shaft body 20 and the rubber material 18 are integrated with each other and are discharged from the discharge opening 12c as the rubber roll 24, the distortion occurring in the rubber material 18 of the rubber roll 24 is released, so that deformation occurs in the rubber roll. Specifically, the rubber material 18 at the outer peripheral side of the rubber roll 24 contracts due to the released tensile stress, and the rubber material 18 at the inner peripheral side of the rubber roll 24 expands due to the released compressive stress. That is, the deformation of the rubber material 18 caused by the released distortion leads to the uneven thickness of the rubber roll 24 in the axial direction.

From such an event in the rubber roll producing machine 100 described as a comparative example, the inventors have obtained the following knowledge. In order to suppress the uneven thickness of the rubber roll 24 in the axial direction, the distortion occurring in the rubber material 18 needs to be suppressed. In order to attain this, the difference in speed of the rubber material 18 flowing through the annular passageway 14 needs to be corrected (small).

Therefore, in the rubber roll producing machine 10 of the exemplary embodiment, different surface treatment is performed for each of the outer peripheral surface 16a of the inner die 16 (the inner wall of the annular passageway) and the inner peripheral surface 12a of the outer die 12 (the outer wall of the annular passageway) in the portion which forms the annular passageway 14, and the friction coefficient of the outer peripheral surface 16a of the inner die 16 against the rubber material 18 is set to be larger than the friction coefficient of the inner peripheral surface 12a of the outer die 12 against the rubber material 18. In this way, the difference in speed of the rubber material 18 which flows through the annular passageway 14 is corrected. That is, a difference in speed of the rubber material 18 which flows through the annular passageway 14 is corrected in a manner such that the friction coefficient of the outer peripheral surface 16a is adjusted to be larger than the friction coefficient of the inner peripheral surface even though the surface area of the outer peripheral surface 16a of the inner die 16 is smaller than the surface area of the inner peripheral surface 12a of the outer die 12 in the portion which forms the annular passageway 14. Accordingly, the distortion occurring in the rubber material 18 of the rubber roll 24 which is discharged from the discharge opening 12c is suppressed, and the uneven thickness of the rubber roll 24 in the axial direction is suppressed.

Hereinafter, the test result for the uneven thickness of the rubber roll 24 in the axial direction will be described.

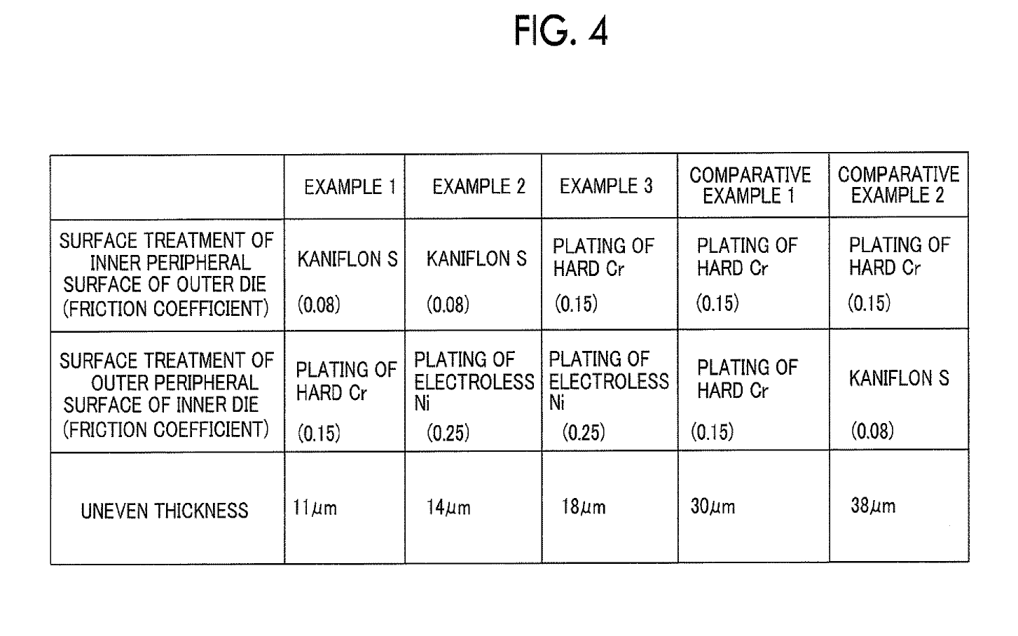

FIG. 4 is a table illustrating a test result for the uneven thickness of the rubber roll 24 in the axial direction when various combinations of surface treatments are performed on the inner peripheral surface 12a of the outer die 12 and the outer peripheral surface 16a of the inner die 16.

In Example 1, a rubber roll is produced by a rubber roll producing machine in a manner such that a Kaniflon coating process (name of commodity: Kaniflon S manufactured by JAPAN KANIGEN Co., Ltd.) is performed on the inner peripheral surface 12a of the outer die 12 due to electroless nickel PTFE complex plating coating process in which polytetrafluoroethylene (PTFE) is dispersed in electroless nickel coating and hard chromium plating is performed on the outer peripheral surface 16a of the inner die 16.

In Example 2, a rubber roll is produced by a rubber roll producing machine in a manner such that a Kaniflon coating process (name of commodity: Kaniflon S manufactured by JAPAN KANIGEN Co., Ltd.) is performed on the inner peripheral surface 12a of the outer die 12 and electroless nickel plating is performed on the outer peripheral surface 16a of the inner die 16.

In Example 3, a rubber roll is produced by a rubber roll producing machine in a manner such that hard chromium plating is performed on the inner peripheral surface 12a of the outer die 12 and electroless nickel plating is performed on the outer peripheral surface 16a of the inner die 16.

In Comparative Example 1, a rubber roll is produced by a rubber roll producing machine in a manner such that hard chromium plating is performed on the inner peripheral surface 12a of the outer die 12 and the outer peripheral surface 16a of the inner die 16.

In Comparative Example 2, a rubber roll is produced by a rubber roll producing machine in a manner such that hard chromium plating is performed on the inner peripheral surface 12a of the outer die 12 and a Kaniflon coating process (name of commodity: Kaniflon S manufactured by JAPAN KANIGEN Co., Ltd.) is performed on the outer peripheral surface 16a of the inner die 16.

The numerical values put in round brackets in FIG. 4 indicate the friction coefficients for the Kaniflon coating process, the hard chromium plating, and the electroless nickel plating. These friction coefficients are measurement values obtained as below. Test pieces are made by performing various surface treatments on a plate material of SS400 (JIS standard) and the friction coefficients of the test pieces are measured by a reciprocating friction test machine (name of measurement machine: HEIDON-14D manufactured by Shinto Scientific Co., Ltd.). Then, the friction coefficients are estimated as the friction coefficients against the rubber material 18.

As shown in the drawing, in the rubber roll producing machines of Example 1 to Example 3, the friction coefficient of the outer peripheral surface 16a of the inner die 16 against the rubber material 18 is set to be larger than the friction coefficient of the inner peripheral surface 12a of the outer die 12 against the rubber material 18. Thus, the rubber roll producing machines of Example 1 to Example 3 are the rubber roll producing machines which are included in the exemplary embodiment. On the other hand, in the rubber roll producing machine of Comparative Example 1, the friction coefficient of the outer peripheral surface 16a of the inner die 16 against the rubber material 18 is equal to the friction coefficient of the inner peripheral surface 12a of the outer die 12 against the rubber material 18. Further, in the rubber roll producing machine of Comparative Example 2, the friction coefficient of the outer peripheral surface 16a of the inner die 16 against the rubber material 18 is set to be smaller than the friction coefficient of the inner peripheral surface 12a of the outer die 12 against the rubber material 18. Thus, the rubber roll producing machines of Comparative Example 1 and Comparative Example 2 are the rubber roll producing machines which are not included in the exemplary embodiment.

Furthermore, the other conditions are the same when the rubber roll is produced by the rubber roll producing machines of Example 1 to Example 3 and Comparative Example 1 and Comparative Example 2.

Specifically, as the conductive shaft body 20, a conductive shaft body is used in which electroless nickel plating with a thickness of 8 μm is performed on steel with a diameter of 8 mm and a length of 330 mm during a drawing process.

Further, as the rubber material 18, a rubber material is used in which 95 parts by mass of epichlorohydrin rubber (name of commodity: Zecro G-3106 manufactured by Zeon Corporation), 5 parts by mass of liquid NBR (JSR N280), 5 parts by mass of zinc oxide (name of commodity: heterogeneous zinc oxide manufactured by Hakusuitech Ltd.), 1 part by mass of stearic acid (name of commodity: stearic acid S manufactured by Kao Corporation.), 20 parts by mass of carbon black (name of commodity: 3030B manufactured by Mitsubishi Chemical Corporation.), 40 parts by mass of calcium carbonate (name of commodity: Whiten SSB manufactured by Shiraishi Kogyo), 2 parts by mass of an ion conductive agent (quaternary ammonium salt) (name of commodity: KS-555 manufactured by Kao Corporation.), 1 part by mass of Dibenzothiazyl sulfide (name of commodity: Nocceler DM manufactured by Ouchi Shinko Chemical Industrial Co., Ltd.), 1 part by mass of Tetramethylthiuram monosulfide (name of commodity: Nocceler TS manufactured by Ouchi Shinko Chemical Industrial Co., Ltd.), and 1 part by mass of sulfur (name of commodity: Sulfax 200S manufactured by Tsurumi Chemical Corporation.) are kneaded by using a hermetic mixer and an open roll.

Further, the rubber material 18 is introduced into the rubber roll producing machine at a constant flow rate by using a single axis type extruding machine, and the conductive shaft body 20 is fed from the insertion hole 16b at a constant speed, thereby producing the rubber roll 24 so that the rubber material 18 is coated throughout the conductive shaft body 20 with a length of 330 mm so as to form a coating with a diameter of 12 mm thereon. Further, the temperature of the rubber roll producing machine is set to 80° C., and the outer die 12 and the inner die 16 are heated up to the temperature.

Further, in the measurement of the uneven thickness of the rubber roll 24 in the axial direction, laser diameter measurement equipment (name of measurement equipment: ROLL 2000 manufactured by Asaka Riken Inc.) is used. Specifically, the outer diameter of each of both end portions of the rubber roll 24 at the position of 15 mm is first measured by using the laser diameter measurement equipment, an imaginary line connecting the two positions at the outer diameter is set, the outer diameter of, for example, each of positions of every 1 mm in the center portion along 300 mm of the rubber roll is measured, and then the maximal value of the distance (the gap) between the outer diameter for each position and the imaginary line is set as the uneven thickness.

As shown in Table of FIG. 4, the uneven thickness of each of the rubber rolls 24 which are produced by the rubber roll producing machines of Example 1 to Example 3 and included in the exemplary embodiment is smaller than the uneven thickness of each of the rubber rolls 24 which are produced by the rubber roll producing machines of Comparative Example 1 and Comparative Example 2 and not included in the exemplary embodiment. It is considered that the result is obtained by the above-described reasons. That is, with regard to the portion which forms the annular passageway 14, different surface treatment is performed for each of the outer peripheral surface 16a of the inner die 16 and the inner peripheral surface 12a of the outer die 12, and the friction coefficient of the outer peripheral surface 16a of the inner die 16 against the rubber material 18 is set to be larger than the friction coefficient of the inner peripheral surface 12a of the outer die 12 against the rubber material 18, so that a difference in speed of the rubber material 18 which flows through the annular passageway 14 is corrected, and the distortion occurring in the rubber material 18 of the rubber roll 24 which is discharged from the discharge opening 12c is suppressed.

As described above, the rubber roll producing machine 10 according to the exemplary embodiment includes: the outer die 12 which is formed in a cylindrical shape; the inner die 16 which is disposed inside the outer die 12 so as to form the annular passageway 14 between the inner die and the outer die 12, has the outer peripheral surface 16a with a friction coefficient larger than that of the inner peripheral surface 12a of the outer die 12 in the portion forming the annular passageway 14, and has the insertion hole 16b formed at the center portion thereof so as to insert the conductive shaft body 20 therethrough; and the discharge portion 22 which allows the rubber material 18 flowing out from the annular passageway 14 to contact the conductive shaft body 20 coming out from the insertion hole 16b so that the rubber material 18 and the conductive shaft body 20 are integrated with each other and are disposed to the outside.

Further, the method of producing the rubber roll 24 according to the exemplary embodiment includes: pouring the rubber material 18 into the annular passageway 14 and inserting the conductive shaft body 20 into the insertion hole 16b using the rubber roll producing machine 10; making the rubber material 18 flowing out from the annular passageway 14 contact the conductive shaft body 20 coming out from the insertion hole 16b; and discharging the rubber material 18 and the conductive shaft body 20 in an integrated state.

Accordingly, the uneven thickness of the produced rubber roll 24 is suppressed.

Furthermore, in the above-described rubber roll producing machine 10, the friction coefficient of the outer peripheral surface 16a of the inner die 16 against the rubber material 18 is set to be larger than the friction coefficient of the inner peripheral surface 12a of the outer die 12 against the rubber material 18 by performing different surface treatment for each of the outer peripheral surface 16a of the inner die 16 and the inner peripheral surface 12a of the outer die 12. However, the friction coefficient of the outer peripheral surface 16a of the inner die 16 against the rubber material 18 may be set to be larger than the friction coefficient of the inner peripheral surface 12a of the outer die 12 against the rubber material 18 by changing each surface roughness of the outer peripheral surface and the inner peripheral surface through, for example, sandblasting. Further, a macroscopic resistance member may be formed by the outer peripheral surface 16a of the inner die 16.

Further, in the above-described rubber roll producing machine 10, each of the outer die 12 and the inner die 16 is formed by one member, but each of the outer die 12 and the inner die 16 may be formed by plural members.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A rubber roll producing machine comprising:
an outer member that is formed in a cylindrical shape;
an inner member that is disposed inside the outer member so as to form an annular passageway between the inner member and the outer member, has an outer peripheral surface with a friction coefficient against a rubber material larger than that of an inner peripheral surface of the outer member in a portion of forming the annular passageway, and has an insertion hole formed at a center portion thereof so as to insert a shaft member therethrough; and
a discharge portion which allows the rubber material flowing out from the annular passageway to contact the shaft member coming out from the insertion hole and discharges the rubber material and the shaft member to the outside in an integrated state.

2. The rubber roll producing machine according to claim 1, wherein an electroless nickel PTFE complex plating coating process is performed on the inner peripheral surface of the outer member.

3. A method of producing a rubber roll comprising:
pouring the rubber material through an annular passageway and inserting the shaft member into the insertion hole using the rubber roll producing machine according to claim 1;
making the rubber material flowing out from the annular passageway contact the shaft member coming out from the insertion hole; and
discharging the rubber material and the shaft member to the outside in an integrated state.

4. A method of producing a rubber roll comprising:
pouring the rubber material through an annular passageway and inserting the shaft member into the insertion hole using the rubber roll producing machine according to claim 2;
making the rubber material flowing out from the annular passageway contact the shaft member coming out from the insertion hole; and
discharging the rubber material and the shaft member to the outside in an integrated state.
